(19) United States
(12) Patent Application Publication
(10) Pub. No.: US 2017/0287045 A1
(43) Pub. Date: Oct. 5, 2017

(54) Method and Apparatus for Recommending Derivative Product Information

(71) Applicants: Le Holdings (Beijing) Co., Ltd., Beijing (CN); Lemall (Beijing) Co., Ltd., Beijing (CN)

(72) Inventors: Tianxiang Zheng, Beijing (CN); Yu Bai, Beijing (CN)

(21) Appl. No.: 15/218,547

(22) Filed: Jul. 25, 2016

Related U.S. Application Data
(63) Continuation of application No. PCT/CN2016/089772, filed on Jul. 12, 2016.

(30) Foreign Application Priority Data
Mar. 30, 2016 (CN) 2016101925136

(51) Int. Cl. G06Q 30/06

(52) U.S. Cl. CPC G06Q 30/0631; G06Q 30/0623

(57) ABSTRACT

Disclosed are a method and apparatus for recommending derivative product information, includes: acquiring attribute information of a main product browsed by a user in a network mall; determining whether the main product has a corresponding derivative product or not according to the attribute information and determining whether the merchant of the main product sells the derivative product or not according to the attribute information; and displaying prompt information of the derivative product on a web used for selling the main product under the condition that the merchant sells the derivative product. The present disclosure are capable of recommending other derivative products of the merchant to the user when the user browses the product of one merchant stationed in the network mall so as to better recommend products of the same merchant to the user, thereby improving the market competitiveness of the network mall.

### CROSS REFERENCE TO RELATED APPLICATIONS

This application is a continuation of International Application No. PCT/CN2016/089772, filed on Jul. 12, 2016, which is based upon and claims priority to Chinese Patent Application No. 2016101925136, filed on Mar. 30, 2016, the entire contents of which are incorporated herein by reference.

### TECHNICAL FIELD

The present disclosure relates to the field of Internet information processing and particularly relates to a method and apparatus for recommending derivative product information.

### BACKGROUND

With the development of Internet network and smart mobile devices, more and more users choose on-line shopping so as to conveniently and rapidly access commodities. The users can inquire information such as prices and the like of all products provided by all merchants stationed in the network mall through the network mall as a network platform. At present, more and more network malls appear, for example, Taobao and Alibaba at the beginning, Jingdong Mall, and Letv Mall at present and the like; the competition among the network malls is also increasingly fierce.

In general, whether products can be better recommended to the users is one of reasons why merchants choose to station network malls as well as one of reasons why the users choose to shop in the network malls. However, no recommending method, which is easily adopted by the user, is available at present.

### SUMMARY

In view of this, the technical problem to be solved by the present disclosure is to how to better recommend the products to the users, thereby improving the market competitiveness of the network mall.

In order to solve the above technical problem, according to one aspect of the present disclosure, the present disclosure provides a method for recommending derivative product information, including the following steps: acquiring attribute information of a main product browsed by a user in a network mall; determining whether the main product has a corresponding derivative product or not according to the attribute information and determining or not the merchant of the main product sells the derivative product according to the attribute information under the condition that the main product has the derivative product; and displaying prompt information of the derivative product on a web used for selling the main product under the condition that the merchant sells the derivative product, wherein the prompt information is linked with the web used for selling the derivative product.

In a possible implementation way, the above recommending method also includes the following steps: pre-storing a corresponding relationship between the main product and a corresponding derivative product; and determining whether the main product has a corresponding derivative product or not according to the corresponding relationship.

According to the above recommending method, in a possible implementation way, the attribute information includes at least one of the merchant information, name, content, variety and price of the main product; under the condition that the name of the main product is a film ticket and the content is a film name corresponding to the film ticket, the derivative product is at least one of foods, dolls or mascots corresponding to characters of the film; and the user obtains the main product and/or the derivative product in a cinema determined according to the merchant information.

In a possible implementation way, the above recommending method also includes the following steps: generating voucher information used for getting the main product under the condition that the user determines to buy the main product, and popping out recommending information used for recommending the derivative product to the user in form of a pop-up box.

In a possible implementation way, the above recommending method also includes a step of generating voucher information used for getting the derivative product under the condition that the user determines to buy the derivative product.

In order to solve the above technical problem, according to another aspect of the present disclosure, the present disclosure provides an apparatus for recommending derivative product information, including: an acquiring module for acquiring attribute information of a main product browsed by a user in a network mall; a determining module connected with the acquiring module and used for determining whether the main product has a corresponding derivative product or not according to the attribute information and determining whether the merchant of the main product sells the derivative product or not according to the attribute information under the condition that the main product has a derivative product; and a prompting module connected with the determining module and used for displaying prompt information of the derivative product on a web used for selling the main product under the condition that the merchant sells the derivative product, wherein the prompt information is linked with the web used for selling the derivative product.

In a possible implementation way, the above apparatus for recommending derivative product information also includes a storage module connected with the determining module and used for pre-storing a corresponding relationship between the main product and the corresponding derivative product; the determining module is also used for determining whether the main product has a corresponding derivative product or not according to the corresponding relationship.

According to the above apparatus for recommending derivative product information, in a possible implementation way, the attribute information includes at least one of the merchant information, name, content, variety and price of the main product; under the condition that the name of the main product is a film ticket and the content is a film name corresponding to the film ticket, the derivative product is at least one of foods, dolls or mascots corresponding to characters of the film; and the user obtains the main product and/or the derivative product in a cinema determined according to the merchant information.

According to the above apparatus for recommending derivative product information, in a possible implementation way, the determining module is also used for determining whether the user determines to buy the main product; the apparatus for recommending derivative product information also includes: a generating module connected with the determining module and used for generating voucher information used for getting the main product under the condition that the user determines to buy the main product; and a pop-up module connected with the determining module and/or the generating module and used for popping out the recommending information used for recommending the derivative product to the user in form of a pop-up box under the condition that the user determines to buy the main product.

According to the above apparatus for recommending derivative product information, in a possible implementation way, the determining module is also used for determining whether the user determines to buy the derivative product; the generating module is also used for generating voucher information used for getting the derivative product under the condition that the user determines to buy the derivative product.

The method and the apparatus for recommending derivative product information according to the present disclosure are implemented by acquiring the attribute information of a main product browsed by the user in the network mall, determining whether the main product has a corresponding derivative product or not according to the attribute information, determining whether the merchant of the main product sells the derivative product or not according to the attribute information under the condition that the main product has the derivative product, and displaying prompt information of the derivative product on a web used for selling the main product under the condition that the merchant sells the derivative product, wherein the prompt information is linked with the web used for selling the derivative product. The method and apparatus for recommending derivative product information according to the embodiments of the present disclosure are capable of recommending other derivative products of the merchant to the user when the user browses products of a merchant stationed in the network mall so as to better recommend products of the same merchant to the user, thereby improving the market competitiveness of the network mall.

According to the detailed illustration below about the exemplary embodiments with reference to the drawings, other features and aspects of the present disclosure will become apparent.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of a method for recommending derivative product information according to one embodiment of the present disclosure;

FIG. 2 shows a block diagram of the structure of an apparatus for recommending derivative product information according to one embodiment of the present disclosure;

FIG. 3 shows a block diagram of the structure of an apparatus for recommending derivative product information according to another embodiment of the present disclosure;

FIG. 4 shows a block diagram of the structure of an apparatus for recommending derivative product information according to a further embodiment of the present disclosure.

### DETAILED DESCRIPTION

The preferred embodiments of the present disclosure will be illustrated below with reference to the accompanying drawings. It should be understood that the preferred embodiments described here are merely used for illustrating and explaining the present disclosure but not for limiting the present disclosure.

### Embodiment 1

FIG. 1 shows a flow chart of a method for recommending derivative product information according to one embodiment of the present disclosure. As shown in FIG. 1, the recommending method mainly may include the following steps.

step S110, the attribute information of a main product browsed by the user in the network mall is acquired, wherein the attribute information may include at least one of the merchant information, name, content, variety and price of the main products.

step S120, whether the main product has a corresponding derivative product or not is determined, according to the attribute information, and performing the step S130 of determining whether the merchant of the main product sells the derivative product or not according to the attribute information under the condition that the main product has the derivative product.

The step S140 of displaying prompt information of the derivative product on a web used for selling the main product is performed under the condition that the merchant sells the derivative product, wherein the prompt information is linked with the web used for selling the derivative product. The prompt information may be the name or the appearance picture of the derivative product, so that the user can know the information of the derivative product, under the condition that the user wants to know more detailed information of the derivative product or desires to buy the derivative product, the web for selling the main product skips to the page for selling the derivative product through a manner of clicking on the prompt information.

It should be noted that the main product and the derivative product may be any products sold by the network, for example, electronic products such as television sets, refrigerators and mobile phones and the like; the products also may be recreational products such as books, foods, film tickets and concert tickets and the like.

The method for recommending derivative product information according to the embodiment can recommend the corresponding derivative product to the user in real time so as to recommend other products of the same merchant to the user when the user browses the products of one merchant stationed in the network mall, thereby improving the market competitiveness of the network mall.

### Embodiment 2

Besides the steps included by the recommending method of the Embodiment 1, the method for recommending derivative product information according to the embodiment may also include a step of pre-storing a corresponding relationship between the main product and the corresponding derivative product, wherein in the step S120, whether there is a corresponding derivative product of the main product or not is determined according to the corresponding relationship; in this way, the probability that the main product has a corresponding derivative product can be increased, so that the product can be recommended to the user as much as possible.

In a possible implementation way, under the condition that the name of the main product is a film ticket and the content is a film name corresponding to the film ticket, the derivative product is at least one of foods, dolls or mascots corresponding to roles of the film; and the user obtains the main product and/or the derivative product in a cinema determined according to the merchant information. For example, the film name corresponding to the film ticket is Avatar; the corresponding derivative product may be Avatar doll. Under this circumstance, if the user buys the film ticket and the corresponding Avatar doll at the same time, the user can obtain the film ticket and the corresponding Avatar doll in the cinema determined according to the merchant information. Of course, the user can also choose to only buy the film ticket and not buy the Avatar doll. In addition, the user can also choose to not buy the film ticket and only buy the Avatar doll.

It should be noted that the voucher information used for getting the main product can be generated under the condition that the user determines to buy the main product; the voucher information may be a two-dimension code or a character verification code; and the recommending information used for recommending the derivative product to the user is popped out in form of a pop-up box. Similarly, the voucher information used for getting the derivative product can also be generated under the condition that the user determines to buy the derivative product; and the voucher information may be a two-dimension code or a character verification code.

The method for recommending derivative product information according to the embodiment can recommend the corresponding derivative product to the user in real time so as to recommend other products of the same merchant to the user when the user browses the product of one merchant stationed in the network mall, thereby improving the market competitiveness of the network mall.

### Embodiment 3

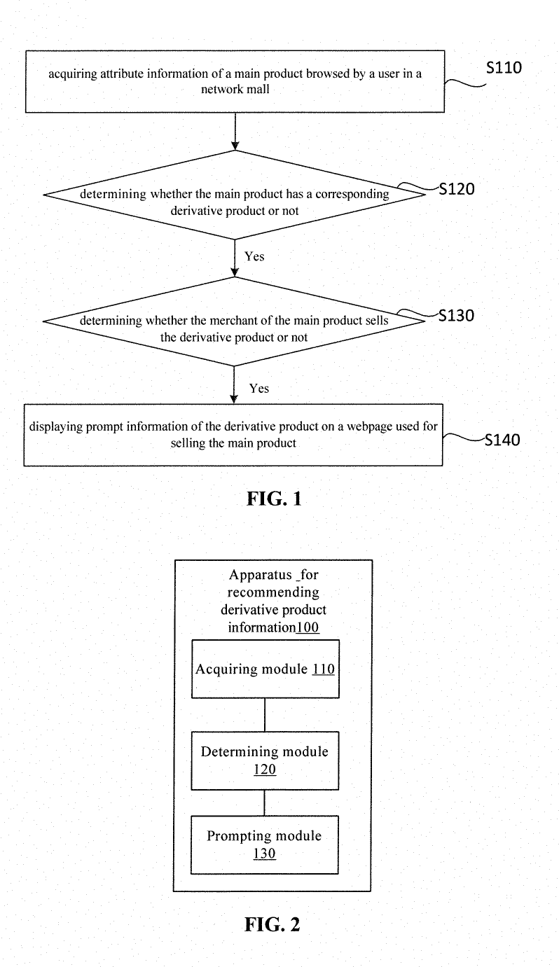

FIG. 2 shows a block diagram of the structure of an apparatus for recommending derivative product information according to one embodiment of the present disclosure. As shown in FIG. 2, the apparatus for recommending derivative product information 100 may mainly include an acquiring module 110, a determining module 120 and a prompting module 130, wherein the acquiring module is used for acquiring attribute information of a main product browsed by a user in a network mall; the determining module 120 is connected with the acquiring module, is used for determining whether the main product has a corresponding derivative product or not according to the attribute information and is also used for determining whether the merchant of the main product sells the derivative product or not according to the attribute information under the condition that the main product has the derivative product; the prompting module 130 is connected with the determining module 120 and is used for displaying prompt information of the derivative product on a web used for selling the main product under the condition that the merchant sells the derivative product, wherein the prompt information is linked with the web used for selling the derivative product.

The specific implementation mechanisms of the above-mentioned acquiring module 110, determining module 120 and prompting module 130 can refer to the description about the steps S110-S140 in the Embodiment 1 and the FIG. 1; and the device 100 for recommending derivative product information described by the Embodiment can achieve the same effect as the Embodiment 1, which is not described here again.

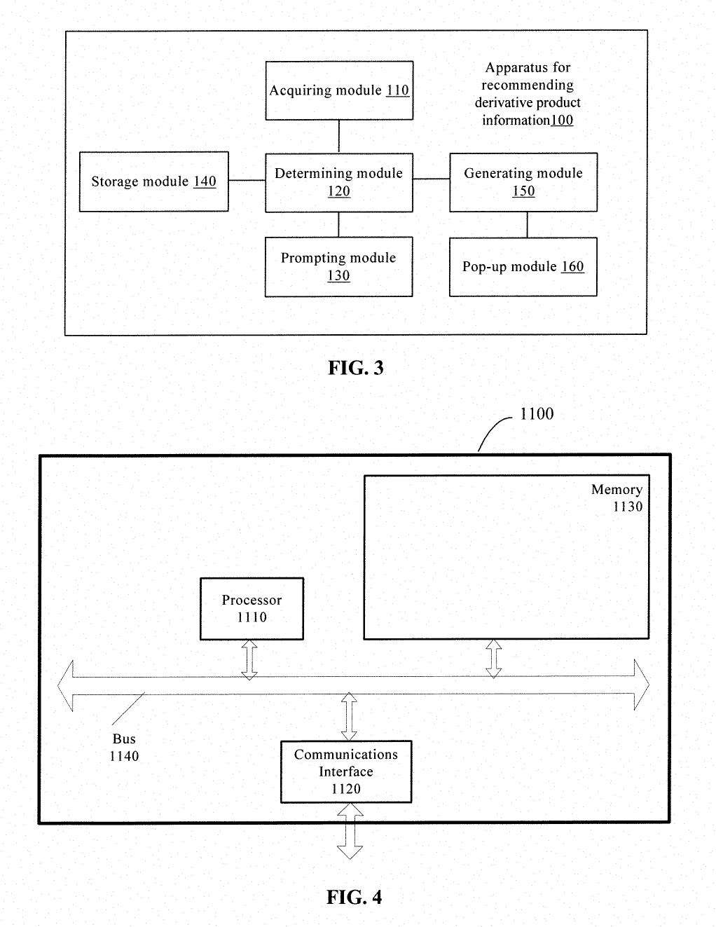

In a possible implementation way, as shown in FIG. 3, the device 100 for recommending derivative product information according to the embodiment of the present disclosure may also include a storage module 140, wherein the storage module 140 is connected with the determining module 120 and is used for pre-storing a corresponding relationship between the main product and the corresponding derivative product; the determining module 120 is also used for determining whether the main product has a corresponding derivative product or not according to the corresponding relationship. In this way, the probability that the main product has the corresponding derivative product can be increased, so that the products can be recommended to the user as much as possible.

In a possible implementation way, the attribute information includes at least one of the merchant information, name, content, variety and price of the main product; under the condition that the name of the main product is a film ticket and the content is a film name corresponding to the film ticket, the derivative product is at least one of foods, dolls or mascots corresponding to roles of the film; and the user obtains the main product and/or the derivative product in a cinema determined according to the merchant information.

In a possible implementation way, the determining module is also used for determining whether the user determines to buy the main product. As shown in FIG. 3, the device 100 for recommending derivative product information according to the embodiment of the present disclosure may also include a generating module 150 and a pop-up module 160. The generating module 150 is connected with the determining module 120 and is used for generating voucher information used for getting the main product under the condition that the user determines to buy the main product; the pop-up module 160 can be connected with the determining module 120 or the generating module 150, can also be connected with both the determining module 120 and the generating module 150, and is used for popping out the recommending information used for recommending the derivative product to the user in form of a pop-up box under the condition that the user determines to buy the main product. FIG. 3 shows the condition that the pop-up module 160 is connected with the generating module 150. Under this condition, the generating module 150 is used for sending the information that the user determines to buy the main product to the pop-up module 160.

In addition, in a possible implementation way, the determining module 120 is also used for determining whether the user determines to buy the derivative product; the generating module 150 is also used for generating voucher information used for getting the derivative product under the condition that the user determines to buy the derivative product.

The specific implementation mechanisms of the above-mentioned modules can refer to the description in the Embodiment 2; and the device 100 for recommending the derivative product information described by the Embodiment can achieve the same effect as the Embodiment 2, which is not described here again.

### Embodiment 4

FIG. 4 shows a block diagram of the structure of an apparatus for recommending derivative product information according to another embodiment of the present disclosure. The device 1100 for recommending the derivative product information may be a host server, a personal computer (PC), or a portable computer or a terminal, etc. The specific embodiments of the present disclosure do not define the specific implementation of computing nodes.

The device 1100 for recommending derivative product information includes a processor 1110, a communications interface 1120, a memory (memory array) 1130 and a bus 1140, wherein the processor 1110, the communications interface 1120 and the memory 1130 are intercommunicated via the bus 1140.

The communications interface 1120 communicates with network elements including a virtual machine management center and a shared memory, etc.

The processor 1110 is used for executing a program. The processor 1110 may be a central processing unit (CPU), an ASIC (Application Specific Integrated Circuit) or one or more integrated circuits configured to implement the embodiments of the present disclosure.

The memory 1130 is used for storing files. The memory 1130 may include a high-speed RAM memory and may also include a non-volatile memory, for example, at least one disk memory. The memory 1130 may also be a memory array. The memory 1130 may also be divided into blocks and the blocks may be combined to be a virtual volume according to a certain rule.

In a possible implementation way, the program may be a program code including a computer operation instruction. The program can be specifically used for acquiring attribute information of a main product browsed by a user in a network mall, determining whether the main product has a corresponding derivative product or not according to the attribute information and determining whether the merchant of the main product sells the derivative product or not according to the attribute information under the condition that the main product has the derivative product, and displaying prompt information of the derivative product on a web used for selling the main product under the condition that the merchant sells the derivative product, wherein the prompt information is linked with the web used for selling the derivative product.

In a possible implementation way, the method also includes the following steps: pre-storing a corresponding relationship between the main product and the corresponding derivative product; and determining whether the main product has a corresponding derivative product or not according to the corresponding relationship.

In a possible implementation way, the attribute information includes at least one of the merchant information, name, content, variety and price of the main product; under the condition that the name of the main product is a film ticket and the content is a film name corresponding to the film ticket, the derivative product is at least one of foods, dolls or mascots corresponding to roles of the film.

In a possible implementation way, the method also includes the following steps: generating voucher information used for getting the main product under the condition that the user determines to buy the main product, and popping out the recommending information used for recommending the derivative product to the user in form of a pop-up box.

In a possible implementation way, the method also includes the following step: generating voucher information used for getting the derivative product under the condition that the user determines to buy the derivative product.

It should be understood by those skilled in the art in the field that the embodiments of the present disclosure can be provided as a method, a system or a computer program product. Therefore, the present disclosure can adopt forms of complete hardware embodiments, complete software embodiments or embodiments with combination of software and hardware. Meanwhile, the present disclosure can adopt forms of computer program products implemented on one or more computer readable memory media (including but not limited to disk memories and optical memories and the like) including computer operable program codes.

The present disclosure is described with reference to the flow charts and/or the block diagrams of the method, the equipment (system) and the computer program product of the embodiments of the present disclosure. It should be understood that each process and/or block diagram in the flow charts and/or the block diagrams and combination of flows and/or blocks in the flow charts and/or the block diagrams can be implemented by computer program instructions. The computer program instructions can be provided for processors of a general-purpose computer, a special-purpose computer, an embedded processor or other programmable data processing devices so as to generate a machine, so that the instructions performed by the processors of the computer or other programmable data processing devices are used for generating a device for implementing a specified function in one flow or multiple flows of the flow charts and/or one block diagrams or multiple blocks of the block diagrams.

The computer program instructions can also be stored in a computer readable memory capable of guiding the computer or other programmable data processing devices to work in a specific manner, so that the instructions stored in the computer readable memory generate a manufacturing product including an instruction device; the instruction device can implement a specific function in one flow or multiple flows of the flow charts and/or one block or multiple blocks of the block diagrams.

The computer program instructions can also be loaded into the computer or other programmable data processing devices, so that a series of operation steps can be performed on the computer or other programmable data processing devices so as to generate the processing implemented by the computer, so that the instructions performed on the computer or other programmable data processing devices provide the steps of implementing the specified function in one flow or multiple flows of the flow charts and/or one block or multiple blocks of the block diagrams.

The above description of the specific exemplary embodiments is for the purposes of illustration and exemplification. The description is not intended to define the present disclosure as the disclosed precise forms; and apparently, lots of changes and variations can be performed according to the teaching. The purpose of selecting and describing the exemplary embodiments is to explain the specific principles and the practical application of the present disclosure, so that those skilled in the art can implement and use various different exemplary embodiments and various different selections and changes of the present disclosure. The scope of the present disclosure can be defined by claims and its equivalent forms.

The above-described embodiments of the device are merely schematic. The units illustrated as separate parts may be or may not be physically separated; parts displayed as the units may be or may not be physical units, namely, the parts can be located in one place or may also be distributed on multiple network units. Part or all of the modules can be selected for implementing the purposes of the solutions of the embodiments according to the practical demands. Those of ordinary skill in the art can understand and implement it without paying the innovative labor.

What is claimed is:

1. A method for recommending derivative product information, executed by an apparatus, the method comprising:
acquiring attribute information of a main product browsed by a user in a network mall;
determining whether the main product has a corresponding derivative product or not according to the attribute information and determining whether the merchant of the main product sells the derivative product or not according to the attribute information under the condition that the main product has the derivative product; and
displaying prompt information of the derivative product on a web used for selling the main product under the condition that the merchant sells the derivative product, wherein the prompt information is linked with the web used for selling the derivative product.

2. The method according to claim 1, further comprising:
pre-storing a corresponding relationship between the main product and the corresponding derivative product; and
determining whether the main product has a corresponding derivative product or not according to the corresponding relationship.

3. The method according to claim 1, wherein the attribute information includes at least one of the merchant information, name, content, variety and price of the main products;
under the condition that the name of the main product is a ticket of a film and the content of the main product is name of a film corresponding to the ticket of the film, the derivative product is at least one of food, doll or mascot corresponding to character of the film.

4. The method according to claim 1, further comprising:
generating a voucher information used for getting the main product under the condition that the user determines to buy the main product, and popping out the recommending information used for recommending the derivative product to the user in form of a pop-up box.

5. The method according to claim 4, further comprising:
generating a voucher information used for getting the derivative product under the condition that the user determines to buy the derivative product.

6. A apparatus for recommending derivative product information, comprising:
an acquiring module for acquiring attribute information of a main product browsed by a user in a network mall;
a determining module connected with the acquiring module and used for determining whether the main product has a corresponding derivative product or not according to the attribute information and determining whether the merchant of the main product sells the derivative product or not according to the attribute information under the condition that the main product has the derivative product;
and a prompting module connected with the determining module and used for displaying prompt information of the derivative product on a web used for selling the main product under the condition that the merchant sells the derivative product, wherein the prompt information is linked with the web used for selling the derivative product.

7. The apparatus according to claim 6, further comprising a storage module connected with the determining module and used for pre-storing a corresponding relationship between the main product and the corresponding derivative product;
and the determining module is also used for determining whether the main product has a corresponding derivative product or not according to the corresponding relationship.

8. The apparatus according to claim 6, wherein
the attribute information includes at least one of the merchant information, name, content, variety and price of the main product;
under the condition that the name of the main product is a film ticket and the content is a film name corresponding to the film ticket, the derivative product is at least one of foods, dolls or mascots corresponding to characters of the film.

9. The apparatus according to claim 6, wherein the determining module is also used for determining whether the user determines to buy the main product; the recommending apparatus further comprises:
a generating module connected with the determining module and used for generating voucher information used for getting the main product under the condition that the user determines to buy the main product;
and a pop-up module connected with the determining module and/or the generating module and used for popping out the recommending information used for recommending the derivative product to the user in form of a pop-up box under the condition that the user determines to buy the main product.

10. The apparatus according to claim 9, wherein
the determining module is also used for determining whether the user determines to buy the derivative product; and
the generating module is also used for generating voucher information used for getting the derivative product under the condition that the user determines to buy the derivative product.

11. An apparatus for recommending derivative product information, comprising:
at least one processor; and
a memory communicably connected with the at least one processor for storing instructions executable by the at least one processor, wherein execution of the instructions by the at least one processor causes the at least one processor to:
acquire attribute information of a main product browsed by a user in a network mall;
determine whether the main product has a corresponding derivative product or not according to the attribute information and determining whether the merchant of the main product sells the derivative product or not according to the attribute information under the condition that the main product has the derivative product; and
display prompt information of the derivative product on a web used for selling the main product under the condition that the merchant sells the derivative product, wherein the prompt information is linked with the web used for selling the derivative product.
